(19) United States
(12) Patent Application Publication
(10) Pub. No.: US 2025/0292741 A1
(43) Pub. Date: Sep. 18, 2025

(54) BACKLIGHT CONTROL CHIP, DRIVING METHOD, BACKLIGHT CONTROL SYSTEM, AND NEAR-EYE DISPLAY DEVICE

(71) Applicants: Beijing BOE Optoelectronics Technology Co., Ltd., Beijing (CN); BOE Technology Group Co., Ltd., Beijing (CN)

(72) Inventors: Zhaohui MENG, Beijing (CN); Zijiao XUE, Beijing (CN)

(21) Appl. No.: 19/221,295

(22) Filed: May 28, 2025

Related U.S. Application Data
(63) Continuation-in-part of application No. 18/705,572, filed on Apr. 28, 2024, now Pat. No. 12,340,768.

(51) Int. Cl. G09G 3/34

(52) U.S. Cl. CPC G09G 3/3406; G09G 2300/0814; G09G 2330/021; G09G 2340/0435

(57) ABSTRACT

Disclosed are a backlight control chip, a driving method, a backlight control system, and a near-eye display device. The backlight control chip is used for driving a backlight module, and includes: a boosting circuit and a gating circuit; where an input terminal of the boosting circuit is electrically connected to a first signal terminal, and an output terminal of the boosting circuit is electrically connected to a first input terminal of the gating circuit; a first control terminal of the gating circuit is electrically connected to a second signal terminal, a second control terminal of the gating circuit is electrically connected to a third signal terminal, and an output terminal of the gating circuit is electrically connected to the backlight module.

### CROSS REFERENCE TO RELATED APPLICATIONS

The present disclosure is a continuation-in-part of U.S. application Ser. No. 18/705,572, filed on Apr. 28, 2024, which is a National Stage of International Application No. PCT/CN2021/141342, filed Dec. 24, 2021, which is hereby incorporated by reference in its entirety.

### TECHNICAL FIELD

The present disclosure relates to the field of the display technology, and in particular to a backlight control chip, a driving method, a backlight control system, and a near-eye display device.

### BACKGROUND

The near-eye display is a current research hotspot, such as the virtual reality display in the form of a helmet and the augmented reality display in the form of smart glasses. The near-eye display can provide people with an unprecedented sense of interaction, and has important application value in many fields such as the telemedicine, industrial design, education, military virtual training, and entertainment, etc.

### SUMMARY

The specific solutions of the backlight control chip, the driving method, the backlight control system, and the near-eye display device provided by the present disclosure are as follows.

On the one hand, an embodiment of the present disclosure provides a backlight control chip for driving a backlight module, including: a boosting circuit and a gating circuit;
where an input terminal of the boosting circuit is electrically connected to a first signal terminal, and an output terminal of the boosting circuit is electrically connected to a first input terminal of the gating circuit;
a first control terminal of the gating circuit is electrically connected to a second signal terminal, a second control terminal of the gating circuit is electrically connected to a third signal terminal, and an output terminal of the gating circuit is electrically connected to the backlight module.

In some embodiments, the gating circuit includes a first gating device and a second gating device;
where a first input terminal of the first gating device is electrically connected to the output terminal of the boosting circuit, a second input terminal of the first gating device is electrically connected to a variable-frequency signal terminal, a control terminal of the first gating device is electrically connected to the second signal terminal, and an output terminal of the first gating device is electrically connected to a first input terminal of the second gating device;
a second input terminal of the second gating device is electrically connected to a fixed frequency signal terminal, a control terminal of the second gating device is electrically connected to the third signal terminal, and an output terminal of the second gating device is electrically connected to the backlight module;
where a fixed frequency signal provided by the fixed frequency signal terminal is used for completing generation of a main clock signal inside the backlight control chip.

In some embodiments, the backlight control chip further includes a first voltage stabilization filter circuit; where an input terminal of the first voltage stabilization filter circuit is electrically connected to the first signal terminal, and an output terminal of the first voltage stabilization filter circuit is electrically connected to the input terminal of the boosting circuit.

In some embodiments, the first voltage stabilization filter circuit includes an even number of cascaded first NOT gates.

In some embodiments, the backlight control chip further includes a protection circuit; where an input terminal of the protection circuit is electrically connected to the first signal terminal, and an output terminal of the protection circuit is electrically connected to the input terminal of the first voltage stabilization filter circuit.

In some embodiments, the protection circuit includes: a first resistor, a second resistor, a third resistor, a diode, a switching transistor, a first AND gate, a second NOT gate, and a third NOT gate;
where a first end of the first resistor is electrically connected to the first signal terminal, and a second end of the first resistor is respectively electrically connected to a first end of the second resistor and the input terminal of the first voltage stabilization filter circuit;
a second end of the second resistor is electrically connected to a first end of the third resistor and a first electrode of the switching transistor, respectively; a second end of the third resistor is grounded;
an anode of the diode is grounded, and a cathode of the diode is electrically connected to the first signal terminal;
a control terminal of the switching transistor is electrically connected to an output terminal of the first AND gate, and a second electrode of the switching transistor is grounded;
a first input terminal of the first AND gate is electrically connected to an output terminal of the second NOT gate, and a second input terminal of the first AND gate is electrically connected to the second signal terminal;
an input terminal of the second NOT gate is electrically connected to a second terminal of the second resistor, and an output terminal of the second NOT gate is electrically connected to an input terminal of the third NOT gate; an output terminal of the third NOT gate is electrically connected to a variable-frequency receiving signal terminal.

In some embodiments, the backlight control chip further includes a second voltage stabilization filter circuit; where an input terminal of the second voltage stabilization filter circuit is electrically connected to the output terminal of the boosting circuit, and an output terminal of the second voltage stabilization filter circuit is electrically connected to a first input terminal of the gating circuit.

In some embodiments, the second voltage stabilization filter circuit includes an even number of cascaded fourth NOT gates.

In some embodiments, the backlight control chip further includes a noise reduction circuit; where an input terminal of the noise reduction circuit is electrically connected to the output terminal of the second voltage stabilization filter circuit, and an output terminal of the noise reduction circuit is electrically connected to the first input terminal of the gating circuit.

In some embodiments, the noise reduction circuit includes: a fourth resistor and a capacitor,
where a first terminal of the fourth resistor is electrically connected to the output terminal of the second voltage stabilization filter circuit, and a second terminal of the fourth resistor is electrically connected to the first input terminal of the gating circuit;
a first electrode of the capacitor is grounded, and a second electrode of the capacitor is electrically connected to the first input terminal of the gating circuit.

In some embodiments, the backlight control chip further includes an analog phase-locked loop; where a first input terminal of the analog phase-locked loop is electrically connected to the output terminal of the gating circuit, and an output terminal of the analog phase-locked loop is electrically connected to the backlight module.

In some embodiments, the backlight control chip further includes a digital phase-locked loop; where a first input terminal of the digital phase-locked loop is electrically connected to the fixed frequency signal terminal, and a first output terminal of the digital phase-locked loop is electrically connected to the second input terminal of the first gating circuit.

In some embodiments, the backlight control chip further includes a third voltage stabilization filter circuit; where a first output terminal of the third voltage stabilization filter circuit is electrically connected to a second input terminal of the digital phase-locked loop, and a second output terminal of the third voltage stabilization filter circuit is electrically connected to a second input terminal of the analog phase-locked loop.

In some embodiments, the third voltage stabilization filter circuit includes: a fifth NOT gate, a sixth NOT gate, a seventh NOT gate, a second AND gate, a third AND gate, a fourth AND gate, and an OR gate; where:
an input terminal of the fifth NOT gate is electrically connected to the third signal terminal, and an output terminal of the fifth NOT gate is electrically connected to a first input terminal of the second AND gate;
a second input terminal of the second AND gate is electrically connected to a trigger signal terminal, and an output terminal of the second AND gate is electrically connected to the second input terminal of the digital phase-locked loop;
an input terminal of the sixth NOT gate is electrically connected to a second output terminal of the digital phase-locked loop, and an output terminal of the sixth NOT gate is electrically connected to a first input terminal of the seventh NOT gate;
a second input terminal of the seventh NOT gate is electrically connected to the output terminal of the fifth NOT gate, and an output terminal of the seventh NOT gate is electrically connected to a first input terminal of the third AND gate;
a second input terminal of the third AND gate is electrically connected to the trigger signal terminal, and an output terminal of the third AND gate is electrically connected to a second output terminal of the analog phase-locked loop;
a first input terminal of the fourth AND gate is electrically connected to the second output terminal of the digital phase-locked loop, a second input terminal of the fourth AND gate is electrically connected to the second signal terminal, and an output terminal of the fourth AND gate is electrically connected to a first input terminal of the OR gate;
a second input terminal of the OR gate is electrically connected to a third output terminal of the digital phase-locked loop, and an output terminal of the OR gate is electrically connected to a display driver chip.

On the other hand, an embodiment of the present disclosure provides a method for driving the aforementioned backlight control chip, including:
the boosting circuit receives a variable-frequency clock signal provided by the first signal terminal and performs boost processing to obtain a synchronous signal, where both the variable-frequency clock signal and the synchronous signal have the same refresh rate as a variable-frequency display; and
the gating circuit receives a first frame rate control signal provided by the second signal terminal, a second frame rate control signal provided by the third signal terminal, and the synchronous signal provided by the boosting circuit; controls output of the synchronous signal in response to the first frame rate control signal and the second frame rate control signal, to drive the backlight module according to the output synchronous signal.

On the other hand, an embodiment of the present disclosure provides a backlight control system, including: a power supply providing chip, a logic control chip, a backlight power supply chip, and a display driver chip; where,
the power supply providing chip is electrically connected to the backlight control chip, the logic control chip, the backlight power supply chip, and the display driver chip, respectively;
the logic control chip is electrically connected to the backlight control chip, the backlight power supply chip, and the display driver chip, respectively;
the backlight power supply chip is electrically connected to the backlight module;
the display driver chip is electrically connected to the display module and the backlight control chip, respectively.

In some embodiments, the gating circuit includes a first gating device and a second gating device;
where a first input terminal of the first gating device is electrically connected to the output terminal of the boosting circuit, a second input terminal of the first gating device is electrically connected to a variable-frequency signal terminal, a control terminal of the first gating device is electrically connected to the second signal terminal, and an output terminal of the first gating device is electrically connected to a first input terminal of the second gating device;
a second input terminal of the second gating device is electrically connected to a fixed frequency signal terminal, a control terminal of the second gating device is electrically connected to the third signal terminal, and an output terminal of the second gating device is electrically connected to the backlight module;
where a fixed frequency signal provided by the fixed frequency signal terminal is used for completing generation of a main clock signal inside the backlight control chip.

In some embodiments, the backlight control chip further includes a first voltage stabilization filter circuit;
where an input terminal of the first voltage stabilization filter circuit is electrically connected to the first signal terminal, and an output terminal of the first voltage stabilization filter circuit is electrically connected to the input terminal of the boosting circuit;
the first voltage stabilization filter circuit includes an even number of cascaded first NOT gates.

In some embodiments, the backlight control chip further includes a protection circuit; where an input terminal of the protection circuit is electrically connected to the first signal terminal, and an output terminal of the protection circuit is electrically connected to the input terminal of the first voltage stabilization filter circuit;
where the protection circuit includes: a first resistor, a second resistor, a third resistor, a diode, a switching transistor, a first AND gate, a second NOT gate, and a third NOT gate;
where a first end of the first resistor is electrically connected to the first signal terminal, and a second end of the first resistor is respectively electrically connected to a first end of the second resistor and the input terminal of the first voltage stabilization filter circuit;
a second end of the second resistor is electrically connected to a first end of the third resistor and a first electrode of the switching transistor, respectively; a second end of the third resistor is grounded;
an anode of the diode is grounded, and a cathode of the diode is electrically connected to the first signal terminal;
a control terminal of the switching transistor is electrically connected to an output terminal of the first AND gate, and a second electrode of the switching transistor is grounded;
a first input terminal of the first AND gate is electrically connected to an output terminal of the second NOT gate, and a second input terminal of the first AND gate is electrically connected to the second signal terminal;
an input terminal of the second NOT gate is electrically connected to a second terminal of the second resistor, and an output terminal of the second NOT gate is electrically connected to an input terminal of the third NOT gate; an output terminal of the third NOT gate is electrically connected to a variable-frequency receiving signal terminal.

On the other hand, an embodiment of the present disclosure provides a near-eye display device, including a display module, a backlight module, and the above-mentioned backlight control system.

### BRIEF DESCRIPTION OF FIGURES

FIG. 1 is a schematic structural diagram of a backlight control chip provided by an embodiment of the present disclosure.

FIG. 2 is a schematic structural diagram of circuits in a backlight control chip provided by an embodiment of the present disclosure.

FIG. 3 is a schematic diagram of a specific structure of circuits in a backlight control chip provided by an embodiment of the present disclosure.

FIG. 4 is a schematic structural diagram of a backlight control system provided by an embodiment of the present disclosure.

FIG. 5 is a timing chart of backlight variable-frequency control provided by an embodiment of the present disclosure.

### DETAILED DESCRIPTION

In order to make the purpose, technical solutions and advantages of the embodiments of the present disclosure clearer, the technical solutions of the embodiments of the present disclosure will be clearly and completely described below in conjunction with the accompanying drawings of the embodiments of the present disclosure. It should be noted that the size and shape of each figure in the drawings do not reflect the true scale, but are only intended to illustrate the present disclosure. And the same or similar reference numerals represent the same or similar elements or elements having the same or similar functions throughout.

Unless otherwise defined, the technical terms or scientific terms used herein shall have the usual meanings understood by those skilled in the art to which the present disclosure belongs. “First”, “second” and similar words used in the description and claims of the present disclosure do not indicate any order, quantity or importance, but are only used to distinguish different components. Words such as “include” or “comprise” mean that the element or item appearing before the word includes the elements or items listed after the word and their equivalents, without excluding other elements or items. “Inner”, “outer”, “upper”, “lower” and so on are only used to indicate the relative positional relationship. When the absolute position of the described object changes, the relative positional relationship may also change accordingly.

In the near-eye display (such as virtual reality (VR), augmented reality (AR), mixed reality (MR)) system, the binocular stereo vision plays an important role. The images seen by the user's two eyes are different, and are displayed on different display screens after being generated separately. After the user wears the near-eye display device, one eye can only see odd-numbered frames of images, and the other eye can only see even-numbered frames of images. After the human eyes acquire these images with differences, the stereoscopic sense is created in the mind.

When the display screen shows that the object is moving, what the eyes see is: as the position changes, the trajectory of the object is a line. Since after the image is displayed in each point on the display screen for a time duration, it will jump to the next point, the best and simplest way to make the image of the object move more continuously is to increase the refresh rate. Considering that a higher refresh rate will increase power consumption, in order to balance the display effect and power consumption, the display screen can be designed as the variable-frequency display. Specifically, when displaying static images, the refresh rate of the display screen is reduced, to reduce power consumption; and when displaying dynamic video images, especially when rapidly changing images on the competitive game, the refresh rate of the display screen is increased, to achieve the best display effect. In the case that the display screen is designed as the variable-frequency display, it is necessary to perform the variable-frequency design on the backlight, and ensure the synchronous variable-frequency of the backlight and the video content. However, merely adjusting the backlight frequency requires re-powering the backlight control chip and updating the driver codes, which may cause the backlight to flash out and then light up again, affecting the user experience.

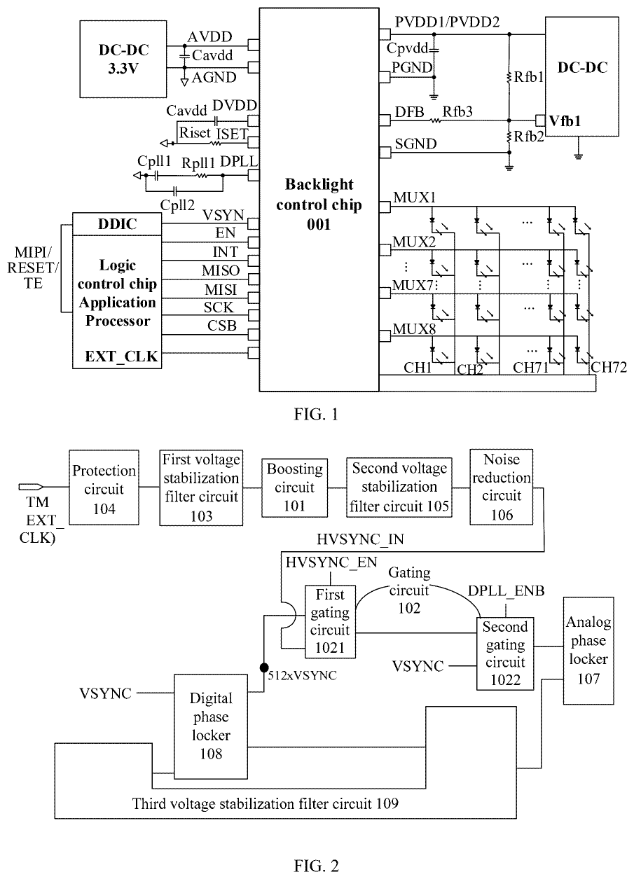

In order to improve the above-mentioned technical problem existing in the related art, an embodiment of the present disclosure provides a backlight control chip 001 for driving a backlight module, as shown in FIG. 1 to FIG. 3, including: a boosting circuit 101, where an input terminal of the boosting circuit 101 is electrically connected to a first signal terminal TM, and an output terminal of the boosting circuit 101 is electrically connected to a first input terminal of the gating circuit 102; and a gating circuit 102, a first control terminal of the gating circuit 102 is electrically connected to a second signal terminal HVSYNC_EN, a second control terminal of the gating circuit 102 is electrically connected to a third signal terminal DPLL_ENB, and an output terminal of the gating circuit 102 is electrically connected to the backlight module.

It should be noted that the first signal terminal TM is used to provide the variable-frequency clock signal EXT_CLK, the second signal terminal HVSYNC_EN is used to provide the first frame rate control signal, and the third signal terminal DPLL-ENB is used to provide the second frame rate control signal.

The boosting circuit 101 is further electrically connected to the interface voltage signal terminal VDDIO and the analog voltage signal terminal AVDD, respectively. The interface voltage signal terminal VDDIO is used to provide voltage signals related to communication protocols, and the analog voltage signal terminal AVDD is used to provide analog voltage signals related to driving.

In some embodiments, the input terminal of the boosting circuit 101 receives the variable-frequency clock signal EXT_CLK provided by the first signal terminal TM, and boost the variable-frequency clock signal EXT_CLK into a synchronous signal HVSYNC_IN, for example boosting to a square wave signal with an amplitude of 3.3V, that is, the output terminal of the boosting circuit 101 outputs the synchronous signal HVSYNC_IN. Both the variable-frequency clock signal EXT_CLK and the synchronous signal HVSYNC_IN have the same refresh rate as the variable-frequency display.

In some embodiments, the gating circuit 102 at least receives the synchronous signal HVSYNC_IN, the first frame rate control signal HVSYNC_EN and the second frame rate control signal DPLL_ENB, and controls output of the synchronous signal HVSYNC_IN in response to the first frame rate control signal HVSYNC_EN and the second frame rate control signal DPLL_ENB.

In the above-mentioned backlight control chip 001 provided by the embodiment of the present disclosure, the external variable-frequency clock signal EXT_CLK is boosted by the boosting circuit 101 into the synchronous signal HVSYNC_IN that can be used by the backlight control chip 001, and the output of the synchronous signal HVSYNC_IN is realized through the gating circuit 102 under the action of the frame rate control signals (such as HVSYNC_EN and DPLL_ENB), which enables the backlight module to work based on the synchronous signal HVSYNC_IN synchronized with the variable-frequency display, so that it is not necessary to re-power the backlight control chip 001, and the backlight module will not flash off and then light up again, improving the user experience.

In some embodiments, the backlight control chip 001 provided by the embodiments of the present disclosure is designed with a working voltage region, a multiplexed channel region, and a logic control input region, wherein the working voltage region is configured to be loaded with the power signal, and the multiplexed channel region is configured to externally connect the lamp bead drive channel of the backlight module through the multiplexing switch(es) MUX, and the logic control input region is configured to be loaded with the control signal. In the present disclosure, the working voltage region and the multiplexed channel region are not improved, in other words, the circuit structure described in the present disclosure belongs to the improvement of the logic control input region. In addition, since the variable-frequency clock signal EXT_CLK (see FIG. 1) is added while other signals remain unchanged in the present application compared with the related art, the functions of the existing signals in FIG. 1 are not expanded in the present disclosure.

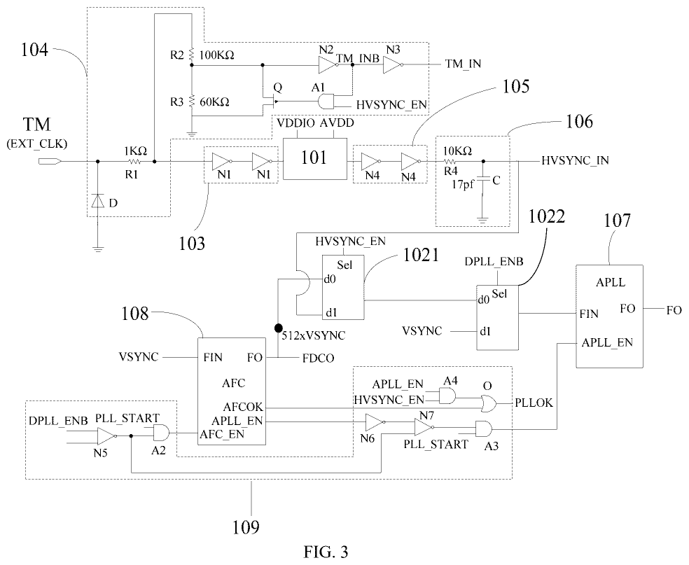

In some embodiments, in the above-mentioned backlight control chip provided by the embodiments of the present disclosure, as shown in FIG. 2 and FIG. 3, the gating circuit 102 receives the synchronous signal HVSYNC_IN, a fixed frequency signal VSYNC, a variable-frequency signal 512xVSYNC, a first frame rate control signal HVSYNC_EN and a second frame rate control signal DPLL_ENB; controls the switching output between the synchronous signal HVSYNC_IN and the variable-frequency signal 512xVSYNC in response to the first frame rate control signal HVSYNC_EN; and then controls the switching output between the synchronous signal HVSYNC_IN or variable-frequency signal 512xVSYNC and the fixed frequency signal VSYNC in response to the second frame rate control signal DPLL_ENB. Here, the fixed frequency signal VSYNC is used for completing the generation of the main clock signal inside the backlight control chip 001, the variable-frequency signal 512xVSYNC is not associated with the refresh rate of the variable-frequency display, and the frame rate control signals include a first frame rate control signal HVSYNC_EN and a second frame rate control signal DPLL_ENB.

Since the variable-frequency signal 512xVSYNC and the fixed frequency signal VSYNC are used in the related art to drive the backlight module to work synchronously with the display screen, the gating circuit 102 in the present disclosure can control the selective output of the synchronous signal HVSYNC_IN, the variable-frequency signal 512xVSYNC or the fixed frequency signal VSYNC, so that the backlight control chip 001 can be compatible with the related art, to facilitate product upgrading. In specific implementation, the fixed frequency signal VSYNC can still be used to complete the generation of the main clock inside the backlight control chip 001 during display. When the synchronous variable-frequency with the display frequency is required, the synchronous signal HVSYNC_IN generated the variable-frequency clock signal EXT_CLK can be referred to, to realize the synchronous variable-frequency work control of the backlight module.

In some embodiments, in the above-mentioned backlight control chip provided by the embodiments of the present disclosure, as shown in FIG. 2 and FIG. 3, the gating circuit 102 may include a first gating device 1021 and a second gating device 1022, where a first input terminal of the first gating device 1021 is electrically connected to the output terminal of the boosting circuit 101, a second input terminal of the first gating device 1021 is electrically connected to a variable-frequency signal terminal 512xVSYNC, a control terminal of the first gating device 1021 is electrically connected to the second signal terminal HVSYNC_EN, and an output terminal of the first gating device 1021 is electrically connected to a first input terminal of the second gating device 1022; a second input terminal of the second gating device 1022 is electrically connected to a fixed frequency signal terminal VSYNC, a control terminal of the second gating device 1022 is electrically connected to the third signal terminal DPLL_ENB, and an output terminal of the second gating device 1022 is electrically connected to the backlight module.

In some embodiments, a control terminal of the first gating device 1021 is loaded with the first frame rate control signal HVSYNC_EN provided by the second signal terminal, a first input terminal of the first gating device 1021 is loaded with the variable-frequency signal 512xVSYNC provided by the variable-frequency signal terminal, and a second input terminal of the first gating device 1021 is loaded with the synchronous signal HVSYNC_IN provided by the boosting circuit 101; and a control terminal of the second gating device 1022 is loaded with the second frame rate control signal DPLL_ENB provided by the third signal terminal, a first input terminal of the second gating device 1022 is electrically connected to the output terminal of the first gating device 1021, and a second input terminal of the second gating device 1022 is loaded with the fixed frequency signal VSYNC.

Specifically, the first gating device 1021 can respond to the first frame rate control signal HVSYNC_EN to realize the switching output between the synchronous signal HVSYNC_IN and the variable-frequency signal 512xVSYNC. Moreover, when the first gating device 1021 outputs the synchronous signal HVSYNC_IN, the second gating device 1022 can respond to the second frame rate control signal DPLL_ENB to realize the switching output between the synchronous signal HVSYNC_IN and the fixed frequency signal VSYNC. When the first gating device 1021 outputs the variable-frequency signal 512xVSYNC, the second gating device 1022 can respond to the second frame rate control signal DPLL_ENB to realize the switching output between the variable-frequency signal 512xVSYNC and the fixed frequency signal VSYNC.

In some embodiments, the variable-frequency signal terminal 512xVSYNC used to provide variable-frequency signals in this application can be a separately set external signal terminal. In some embodiments, the variable-frequency signal terminal 512xVSYNC used to provide variable-frequency signals in the present application cannot be an independent signal terminal, as shown in FIG. 3. The fixed frequency signal terminal VSYNC is electrically connected to the digital phase-locked loop 108, which receives the fixed frequency signal provided by the fixed frequency signal terminal VSYNC. The digital phase-locked loop 108 and the third voltage stabilization filter circuit 109 process the fixed frequency signal to obtain a variable frequency signal. The first output terminal FO of the digital phase-locked loop 108 provides the variable-frequency signal to the second input terminal d1 of the first gating device 1021. At this time, the variable-frequency signal is not provided by the independent signal terminal, which means that the variable-frequency signal is a generated signal inside a backlight control chip. The variable-frequency signal terminal 512xVSYNC is not an independent signal terminal, but a node located between the digital phase-locked loop 108 and the first gating circuit 1021, and can provide the variable-frequency signal.

In some embodiments, the above-mentioned backlight control chip provided in the embodiments of the present disclosure, as shown in FIG. 2 and FIG. 3, may further include a first voltage stabilization filter circuit 103, an input terminal of the first voltage stabilization filter circuit 103 is electrically connected to the first signal terminal TM, and an output terminal of the first voltage stabilization filter circuit 103 is electrically connected to the input terminal of the boosting circuit 101.

In some embodiments, the first voltage stabilization filter circuit 103 performs voltage stabilization and filtering processing on the variable-frequency clock signal EXT_CLK provided by a first signal terminal TM, and provide the variable-frequency clock signal EXT_CLK after the voltage stabilization and filtering processing to the boosting circuit 101.

In some embodiments, the first voltage stabilization filter circuit 103 may include an even number of cascaded first NOT gates (also referred to as inverters) N1. As shown in FIG. 3, the first voltage stabilization filter circuit 103 can include two first NOT gates. The first voltage stabilization filter circuit 103 can amplify the input signal in the forward direction, therefore, an even number of first NOT gates N1 need to be set to ensure the output of the forward signal. Specifically, the variable-frequency clock signal EXT_CLK changes with the change of the refresh rate of the variable-frequency display. After being loaded into the backlight control chip 001, the variable-frequency clock signal EXT_CLK passes through the first voltage stabilization filter circuit 103 including two first NOT gates N1 to form a stable periodic signal that changes following the refresh rate of the variable-frequency display.

In some embodiments, the above-mentioned backlight control chip provided by the embodiments of the present disclosure, as shown in FIG. 2 and FIG. 3, may further include a protection circuit 104, an input terminal of the protection circuit 104 is electrically connected to the first signal terminal TM, and an output terminal of the protection circuit 104 is electrically connected to the input terminal of the first voltage stabilization filter circuit 102. The protection circuit 104 is configured to provide an effective level (such as the high level) of the variable-frequency clock signal EXT_CLK to the first voltage stabilization filter circuit 103 and prevent the effective level (such as the high level) in the first voltage stabilization filter circuit 103 from flowing back to the first signal terminal TM.

In some embodiments, the protection circuit 104 can include: a first resistor R1, a second resistor R2, a third resistor R3, a diode D, a switching transistor Q, a second NOT gate N2, a third NOT gate N3 and a first AND gate A. The first terminal of the first resistor R1 is electrically connected to the first signal terminal TM, and a second terminal of the first resistor R1 is respectively electrically connected to a first terminal of the second resistor R2 and the input terminal of the first voltage stabilization filter circuit 103; a second terminal of the second resistor R2 is electrically connected to a first terminal of the third resistor R3 and a first electrode of the switching transistor Q, respectively; a second terminal of the third resistor R3 is grounded; an anode of the diode D is grounded, and a cathode of the diode D is electrically connected to the first signal terminal TM; a control terminal of the switching transistor Q is electrically connected to an output terminal of the first AND gate A1, and a second electrode of the switching transistor Q is grounded; a first input terminal of the first AND gate A1 is electrically connected to an output terminal of the second NOT gate N2, and a second input terminal of the first AND gate A1 is electrically connected to the second signal terminal HVSYNC_EN; an input terminal of the second NOT gate N2 is electrically connected to a second terminal of the second resistor R2, and an output terminal of the second NOT gate N2 is electrically connected to an input terminal of the third NOT gate N3; an output terminal of the third NOT gate N3 is electrically connected to a variable-frequency receiving signal terminal TM_IN. Where the input terminal of the third NOT gate N3, the output terminal of the second NOT gate N2, and the first input terminal of the first AND gate A1 are connected to form a TM-INB node.

In some embodiments, as shown in FIG. 3, the resistance of the first resistor R1 can be 1 KΩ, the resistance of the second resistor R2 can be 100 KΩ, and the resistance of the third resistor R3 can be 60 KΩ. It should be noted that the resistance values of the above resistors are only partial embodiments and can also be other resistance values that can achieve the corresponding functions of the protection circuit, and are not specifically limited here.

In some embodiments, the above-mentioned backlight control chip provided by the embodiments of the present disclosure, as shown in FIG. 2 and FIG. 3, may further include a second voltage stabilization filter circuit 105, an input terminal of the second voltage stabilization filter 105 circuit is electrically connected to the output terminal of the boosting circuit 101, and an output terminal of the second voltage stabilization filter circuit 105 is electrically connected to a first input terminal of the gating circuit 102.

In some embodiments, the second voltage stabilization filter circuit 105 performs voltage stabilization and filtering processing on the synchronous signal HVSYNC_IN provided by the boosting circuit 101, and provides the synchronous signal HVSYNC_IN after the voltage stabilization and filtering processing to the gating circuit 102, to the first gating circuit 1021.

In some embodiments, the second voltage stabilization filter circuit 105 includes an even number of cascaded fourth NOT gates N4. As shown in FIG. 3, the second voltage stabilization filter circuit 105 can include two fourth NOT gates N4. The second voltage stabilization filter circuit 105 can amplify the input signal in the forward direction, so an even number of fourth NOT gates N4 need to be set to ensure the output of the forward signal.

In some embodiments, the above-mentioned backlight control chip provided by the embodiments of the present disclosure, as shown in FIG. 2 and FIG. 3, may further include a noise reduction circuit 106, an input terminal of the noise reduction circuit 106 is electrically connected to the output terminal of the second voltage stabilization filter circuit 105, and an output terminal of the noise reduction circuit 106 is electrically connected to the first input terminal of the gating circuit 102. The noise reduction circuit 106 performs noise reduction processing on the synchronous signal HVSYNC_IN after the voltage stabilization and filtering processing, and provides the synchronous signal HVSYNC_IN after the noise reduction processing to the gating circuit 102, to the first gating circuit 1021.

In some embodiments, the noise reduction circuit 106 can include: a fourth resistor R4 and a capacitor C, a first terminal of the fourth resistor R4 is electrically connected to the output terminal of the second voltage stabilization filter circuit 105, and a second terminal of the fourth resistor R4 is electrically connected to the first input terminal of the gating circuit 102; a first electrode of the capacitor C is grounded, and a second electrode of the capacitor C is electrically connected to the first input terminal of the gating circuit 102.

That is, the fourth resistor R4 is connected between the second voltage stabilization filter circuit 105 and the gating circuit 102 (specifically, the first gating circuit 1021), and the first electrode of the capacitor C is connected to the gating circuit 102 (specifically, the first gating circuit 1021), and the second electrode of the capacitor C is grounded.

In some embodiments, as shown in FIG. 3, the resistance value of the fourth resistor R4 can be 10 KΩ, and the capacitance value of the capacitor C can be 17 pf. Of course, the resistance value of the fourth resistor R4 and the capacitance value of the capacitor C can also be other values that can achieve the function of the noise reduction circuit 106, and are not specifically limited here.

In some embodiments, the above-mentioned backlight control chip provided by the embodiments of the present disclosure, as shown in FIG. 2 and FIG. 3, may further include an analog phase-locked loop (APLL) 107, a first input terminal of the analog phase-locked loop 107 is electrically connected to the output terminal of the gating circuit 102, and an output terminal of the analog phase-locked loop 107 is electrically connected to the backlight module. The analog phase-locked loop 107 generates a backlight driving timing with the same refresh rate as the output signal of the gating circuit 102 (specifically, the second gating circuit 1022) in response to the output signal of the gating circuit 102 (specifically, the second gating circuit 1022).

In some embodiments, the above-mentioned backlight control chip provided by the embodiments of the present disclosure, as shown in FIG. 2 and FIG. 3, may further include a digital phase-locked loop (AFC) 108, a first input terminal of the digital phase-locked loop 108 is electrically connected to the fixed frequency signal terminal VSYNC, and a first output terminal of the digital phase-locked loop 108 is electrically connected to the second input terminal of the first gating circuit 1021. The digital phase-locked loop 108 receives a fixed frequency signal VSYNC, and generates a variable-frequency signal 512xVSYNC according to the fixed frequency signal VSYNC, and transmits the variable-frequency signal 512xVSYNC to the first terminal of the first gating circuit 1021.

In some embodiments, the above-mentioned backlight control chip provided by the embodiments of the present disclosure, as shown in FIG. 2 and FIG. 3, may further include a third voltage stabilization filter circuit 109, a first output terminal of the third voltage stabilization filter circuit 109 is electrically connected to a second input terminal of the digital phase-locked loop 108, and a second output terminal of the third voltage stabilization filter circuit 109 is electrically connected to a second input terminal of the analog phase-locked loop 107. The third voltage stabilization filter circuit 109 provides a stable analog enabling signal APLL_EN to the analog phase-locked loop 107, and provides a stable digital enabling signal AFC_EN to the digital phase-locked loop 108.

In some embodiments, the third voltage stabilization filter circuit 109 includes: a fifth NOT gate N5, a sixth NOT gate N6, a seventh NOT gate N7, a second AND gate A2, a third AND gate A3, a fourth AND gate A4 and an OR gate O. The input terminal of the fifth NOT gate N5 is electrically connected to the third signal terminal DPLL_ENB, the output terminal of the fifth NOT gate N5 is electrically connected to the first input terminal of the second AND gate A2, the second input terminal of the second AND gate A2 is electrically connected to the trigger signal terminal PLL_START, the output terminal of the second AND gate A2 is electrically connected to the second input terminal (enable input terminal, i.e. the pin used to access the digital enable signal AFC_EN) of the digital phase-locked loop 108, the input terminal of the sixth NOT gate N6 is electrically connected to the second output terminal APLL_RUN of the digital phase-locked loop 108, and the output terminal of the sixth NOT gate N6 is electrically connected to the first input terminal of the seventh NOT gate N7. The second input terminal of the seventh NOT gate N7 is electrically connected to the output terminal of the fifth NOT gate N5, the output terminal of the seventh NOT gate N7 is electrically connected to the first input terminal of the third AND gate A3, the second input terminal of the third AND gate A3 is electrically connected to the trigger signal terminal PLL_START. The output terminal of the third AND gate A3 is electrically connected to the second output terminal (enable input terminal, i.e. the pin used to access the analog enable signal APLL_EN) of the analog phase-locked loop 107, the first input terminal of the fourth AND gate A4 is electrically connected to the second output terminal (analog enable signal) APLL_EN of the digital phase-locked loop, the second input terminal of the fourth AND gate A4 is electrically connected to the second signal terminal HVSYNC_EN, the output terminal of the fourth AND gate A4 is electrically connected to the first input terminal of the OR gate O, the second input terminal of the OR gate O is electrically connected to the third output terminal AFCOK of the digital phase-locked loop 108, and the output terminal of the OR gate O is electrically connected to the display driver chip, providing a digital phase-locked signal PLLOK to the display driver chip.

It should be noted that FIG. 3 is only an example to illustrate the specific structure of various circuits in the backlight driving chip 001 provided by the embodiment of the present disclosure. In specific implementation, the specific structure of the above circuits is not limited to the above structure provided by the embodiment of the present disclosure, but can also be other structures known by those skilled in the art, which are not limited herein.

Based on the same inventive concept, an embodiment of the present disclosure provides a driving method for the above-mentioned backlight control chip, which may include: the boosting circuit receives a variable-frequency clock signal provided by the first signal terminal and performs boost processing to obtain a synchronous signal, where both the variable-frequency clock signal and the synchronous signal have the same refresh rate as a variable-frequency display; and the gating circuit receives a first frame rate control signal provided by the second signal terminal, a second frame rate control signal provided by the third signal terminal, and the synchronous signal provided by the boosting circuit; controls output of the synchronous signal in response to the first frame rate control signal and the second frame rate control signal, to drive the backlight module according to the output synchronous signal.

Since the problem-solving principle of the driving method is similar to the problem-solving principle of the above-mentioned backlight control chip, the implementation of the driving method provided by the embodiment of the present disclosure can refer to the implementation of the above-mentioned backlight control chip provided by the embodiments of the present disclosure, and will not be repeated.

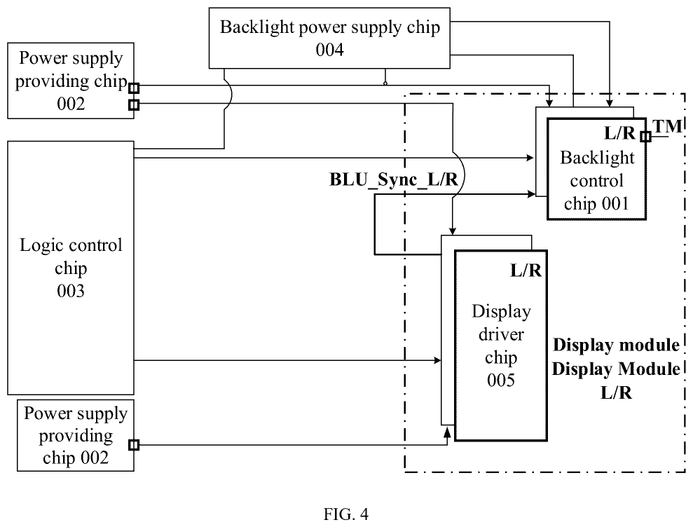

Based on the same inventive concept, an embodiment of the present disclosure provides a backlight control system, as shown in FIG. 4, which may include: the backlight control chip (back light unit integrated circuit, BLU IC) 001 provided by the embodiments of the present disclosure, a power supply providing chip (power management integrated circuit, PMIC) 002, a logic control chip (AP) 003, a backlight power supply (BLU power supply) chip 004 and a display driver chip (display driver integrated circuit, DDIC) 005; the power supply providing chip 002 is electrically connected to the backlight control chip 001, the logic control chip 003, the backlight power supply chip 004, and the display driver chip 005, respectively; the logic control chip 003 is electrically connected to the backlight control chip 001, the backlight power supply chip 004, and the display driver chip 005, respectively; the backlight power supply chip 004 is electrically connected to the backlight module; the display driver chip 005 is electrically connected to the display module and the backlight control chip 001, respectively.

In some embodiments, the power supply providing chip 002 is configured to provide a working voltage for the backlight control chip 001, the logic control chip 003, the backlight power supply chip 004 and the display driver chip 005; the logic control chip 003 is configured to control enabling and logic operation of the backlight control chip 001, the backlight power supply chip 004, and the display driver chip 005; the backlight power supply chip 004 is configured to provide a driving voltage for the backlight module; and the display driver chip 005 is configured to provide a driving voltage for the display module and a fixed frequency signal VSYNC for the backlight control chip 001.

It should be noted that the backlight control chip (BLU IC) 001, power supply providing chip (PMIC) 002, logic control chip (AP) 003, backlight power supply chip (BLU Power Supply) 004, and display driver chip (DDIC) 005 all operate independently with some signals communicating with each other, and these chips are physically independent of each other.

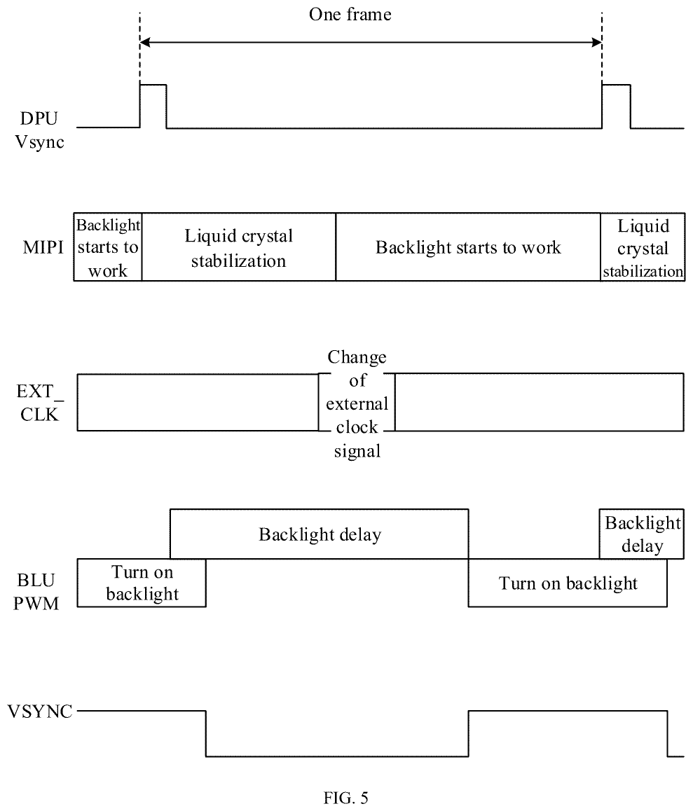

In some embodiments, as shown in FIG. 5, within one frame of time: under the trigger of the display data signal MIPI, the liquid crystal stabilization time duration is first entered, and then the backlight starts to work; the variable-frequency clock signal ECT_CLK as an external dynamic clock signal starts to be input to the backlight control chip 001; the backlight driving timing BLU_PWM is a square wave signal that drives the backlight to light up, and runs through the process of lighting up the backlight module in each region; and at the same time, the fixed frequency signal VSYNC as an external input signal can make the backlight control chip 001 work in a fixed-frequency state. In some embodiments, the backlight control chip 001 can also work in the variable-frequency state based on the synchronous signal HVSYNC_IN generated according to the external variable-frequency clock signal EXT_CLK.

Based on the same inventive concept, an embodiment of the present disclosure provides a near-eye display device, including a display module, a backlight module, and the above-mentioned backlight control system. Since the problem-solving principle of the near-eye display device is similar to the problem-solving principle of the above-mentioned backlight control chip, the implementation of the near-eye display device can refer to the implementation of the above-mentioned backlight control chip, and will not be repeated.

In some embodiments, the above-mentioned near-eye display device provided by the embodiments of the present disclosure may also include, but not limited to components such as a radio frequency unit, a network module, an audio output & input unit, a user input unit, an interface unit, and a memory. In addition, those skilled in the art can understand that the above structure does not constitute a limitation on the above-mentioned near-eye display device provided by the embodiment of the present disclosure. In other words, the above-mentioned near-eye display device provided by the embodiment of the present disclosure may include more or fewer components, or combinations of certain components, or different arrangements of components.

Apparently, those skilled in the art can make various changes and variations to the embodiments of the present disclosure without departing from the spirit and scope of the embodiments of the present disclosure. In this way, if these modifications and variations of the embodiments of the present disclosure fall within the scope of the claims of the present disclosure and their equivalent technologies, the present disclosure also intends to include these modifications and variations.

What is claimed is:

1. A backlight control chip for driving a backlight module, comprising: a boosting circuit and a gating circuit;
wherein an input terminal of the boosting circuit is electrically connected to a first signal terminal, and an output terminal of the boosting circuit is electrically connected to a first input terminal of the gating circuit;
a first control terminal of the gating circuit is electrically connected to a second signal terminal, a second control terminal of the gating circuit is electrically connected to a third signal terminal, and an output terminal of the gating circuit is electrically connected to the backlight module.

2. The backlight control chip according to claim 1, wherein the gating circuit comprises a first gating device and a second gating device;
wherein a first input terminal of the first gating device is electrically connected to the output terminal of the boosting circuit, a second input terminal of the first gating device is electrically connected to a variable-frequency signal terminal, a control terminal of the first gating device is electrically connected to the second signal terminal, and an output terminal of the first gating device is electrically connected to a first input terminal of the second gating device;
a second input terminal of the second gating device is electrically connected to a fixed frequency signal terminal, a control terminal of the second gating device is electrically connected to the third signal terminal, and an output terminal of the second gating device is electrically connected to the backlight module;
wherein a fixed frequency signal provided by the fixed frequency signal terminal is used for completing generation of a main clock signal inside the backlight control chip.

3. The backlight control chip according to claim 1, further comprising a first voltage stabilization filter circuit;
wherein an input terminal of the first voltage stabilization filter circuit is electrically connected to the first signal terminal, and an output terminal of the first voltage stabilization filter circuit is electrically connected to the input terminal of the boosting circuit.

4. The backlight control chip according to claim 3, wherein the first voltage stabilization filter circuit comprises an even number of cascaded first NOT gates.

5. The backlight control chip according to claim 3, further comprising a protection circuit;
wherein an input terminal of the protection circuit is electrically connected to the first signal terminal, and an output terminal of the protection circuit is electrically connected to the input terminal of the first voltage stabilization filter circuit.

6. The backlight control chip according to claim 5, wherein the protection circuit comprises:
a first resistor, a second resistor, a third resistor, a diode, a switching transistor, a first AND gate, a second NOT gate, and a third NOT gate;
wherein a first terminal of the first resistor is electrically connected to the first signal terminal, and a second terminal of the first resistor is respectively electrically connected to a first terminal of the second resistor and the input terminal of the first voltage stabilization filter circuit;
a second terminal of the second resistor is electrically connected to a first terminal of the third resistor and a first electrode of the switching transistor, respectively; a second terminal of the third resistor is grounded;
an anode of the diode is grounded, and a cathode of the diode is electrically connected to the first signal terminal;
a control terminal of the switching transistor is electrically connected to an output terminal of the first AND gate, and a second electrode of the switching transistor is grounded;
a first input terminal of the first AND gate is electrically connected to an output terminal of the second NOT gate, and a second input terminal of the first AND gate is electrically connected to the second signal terminal;
an input terminal of the second NOT gate is electrically connected to a second terminal of the second resistor, and an output terminal of the second NOT gate is electrically connected to an input terminal of the third NOT gate; an output terminal of the third NOT gate is electrically connected to a variable-frequency receiving signal terminal.

7. The backlight control chip according to claim 1, further comprising a second voltage stabilization filter circuit;
wherein an input terminal of the second voltage stabilization filter circuit is electrically connected to the output terminal of the boosting circuit, and an output terminal of the second voltage stabilization filter circuit is electrically connected to a first input terminal of the gating circuit.

8. The backlight control chip according to claim 7, wherein the second voltage stabilization filter circuit comprises an even number of cascaded fourth NOT gates.

9. The backlight control chip according to claim 7, further comprising a noise reduction circuit;
wherein an input terminal of the noise reduction circuit is electrically connected to the output terminal of the second voltage stabilization filter circuit, and an output terminal of the noise reduction circuit is electrically connected to the first input terminal of the gating circuit.

10. The backlight control chip according to claim 9, wherein the noise reduction circuit comprises: a fourth resistor and a capacitor,
wherein a first terminal of the fourth resistor is electrically connected to the output terminal of the second voltage stabilization filter circuit, and a second terminal of the fourth resistor is electrically connected to the first input terminal of the gating circuit;
a first electrode of the capacitor is grounded, and a second electrode of the capacitor is electrically connected to the first input terminal of the gating circuit.

11. The backlight control chip according to claim 2, further comprising an analog phase-locked loop;
wherein a first input terminal of the analog phase-locked loop is electrically connected to the output terminal of the gating circuit, and an output terminal of the analog phase-locked loop is electrically connected to the backlight module.

12. The backlight control chip according to claim 11, further comprising a digital phase-locked loop;
wherein a first input terminal of the digital phase-locked loop is electrically connected to the fixed frequency signal terminal, and a first output terminal of the digital phase-locked loop is electrically connected to the second input terminal of the first gating circuit.

13. The backlight control chip according to claim 12, further comprising a third voltage stabilization filter circuit;
wherein a first output terminal of the third voltage stabilization filter circuit is electrically connected to a second input terminal of the digital phase-locked loop, and a second output terminal of the third voltage stabilization filter circuit is electrically connected to a second input terminal of the analog phase-locked loop.

14. The backlight control chip according to claim 13, wherein the third voltage stabilization filter circuit comprises: a fifth NOT gate, a sixth NOT gate, a seventh NOT gate, a second AND gate, a third AND gate, a fourth AND gate, and an OR gate; wherein:
an input terminal of the fifth NOT gate is electrically connected to the third signal terminal, and an output terminal of the fifth NOT gate is electrically connected to a first input terminal of the second AND gate;
a second input terminal of the second AND gate is electrically connected to a trigger signal terminal, and an output terminal of the second AND gate is electrically connected to the second input terminal of the digital phase-locked loop;
an input terminal of the sixth NOT gate is electrically connected to a second output terminal of the digital phase-locked loop, and an output terminal of the sixth NOT gate is electrically connected to a first input terminal of the seventh NOT gate;
a second input terminal of the seventh NOT gate is electrically connected to the output terminal of the fifth NOT gate, and an output terminal of the seventh NOT gate is electrically connected to a first input terminal of the third AND gate;
a second input terminal of the third AND gate is electrically connected to the trigger signal terminal, and an output terminal of the third AND gate is electrically connected to a second output terminal of the analog phase-locked loop;
a first input terminal of the fourth AND gate is electrically connected to the second output terminal of the digital phase-locked loop, a second input terminal of the fourth AND gate is electrically connected to the second signal terminal, and an output terminal of the fourth AND gate is electrically connected to a first input terminal of the OR gate;
a second input terminal of the OR gate is electrically connected to a third output terminal of the digital phase-locked loop, and an output terminal of the OR gate is electrically connected to a display driver chip.

15. A method for driving the backlight control chip according to claim 1, comprising:
the boosting circuit receives a variable-frequency clock signal provided by the first signal terminal and performs boost processing to obtain a synchronous signal, wherein both the variable-frequency clock signal and the synchronous signal have the same refresh rate as a variable-frequency display; and
the gating circuit receives a first frame rate control signal provided by the second signal terminal, a second frame rate control signal provided by the third signal terminal, and the synchronous signal provided by the boosting circuit; controls output of the synchronous signal in response to the first frame rate control signal and the second frame rate control signal, to drive the backlight module according to the output synchronous signal.

16. A backlight control system, comprising: the backlight control chip according to claim 1, a power supply providing chip, a logic control chip, a backlight power supply chip, and a display driver chip; wherein,
the power supply providing chip is electrically connected to the backlight control chip, the logic control chip, the backlight power supply chip, and the display driver chip, respectively;
the logic control chip is electrically connected to the backlight control chip, the backlight power supply chip, and the display driver chip, respectively;
the backlight power supply chip is electrically connected to the backlight module;
the display driver chip is electrically connected to the display module and the backlight control chip, respectively.

17. The backlight control system according to claim 16, wherein the gating circuit comprises a first gating device and a second gating device;
wherein a first input terminal of the first gating device is electrically connected to the output terminal of the boosting circuit, a second input terminal of the first gating device is electrically connected to a variable-frequency signal terminal, a control terminal of the first gating device is electrically connected to the second signal terminal, and an output terminal of the first gating device is electrically connected to a first input terminal of the second gating device;
a second input terminal of the second gating device is electrically connected to a fixed frequency signal terminal, a control terminal of the second gating device is electrically connected to the third signal terminal, and an output terminal of the second gating device is electrically connected to the backlight module;
wherein a fixed frequency signal provided by the fixed frequency signal terminal is used for completing generation of a main clock signal inside the backlight control chip.

18. The backlight control system according to claim 16, wherein the backlight control chip further comprises a first voltage stabilization filter circuit;
wherein an input terminal of the first voltage stabilization filter circuit is electrically connected to the first signal terminal, and an output terminal of the first voltage stabilization filter circuit is electrically connected to the input terminal of the boosting circuit;
the first voltage stabilization filter circuit comprises an even number of cascaded first NOT gates.

19. The backlight control system according to claim 18, wherein the backlight control chip further comprises a protection circuit;
wherein an input terminal of the protection circuit is electrically connected to the first signal terminal, and an output terminal of the protection circuit is electrically connected to the input terminal of the first voltage stabilization filter circuit;
wherein the protection circuit comprises: a first resistor, a second resistor, a third resistor, a diode, a switching transistor, a first AND gate, a second NOT gate, and a third NOT gate;
wherein a first end of the first resistor is electrically connected to the first signal terminal, and a second end of the first resistor is respectively electrically connected to a first end of the second resistor and the input terminal of the first voltage stabilization filter circuit;
a second end of the second resistor is electrically connected to a first end of the third resistor and a first electrode of the switching transistor, respectively; a second end of the third resistor is grounded;
an anode of the diode is grounded, and a cathode of the diode is electrically connected to the first signal terminal;
a control terminal of the switching transistor is electrically connected to an output terminal of the first AND gate, and a second electrode of the switching transistor is grounded;
a first input terminal of the first AND gate is electrically connected to an output terminal of the second NOT gate, and a second input terminal of the first AND gate is electrically connected to the second signal terminal;
an input terminal of the second NOT gate is electrically connected to a second terminal of the second resistor, and an output terminal of the second NOT gate is electrically connected to an input terminal of the third NOT gate; an output terminal of the third NOT gate is electrically connected to a variable-frequency receiving signal terminal.

20. A near-eye display device, comprising the display module, the backlight module and the backlight control system according to claim 16.
